(19) United States
(12) Patent Application Publication
(10) Pub. No.: US 2023/0039897 A1
(43) Pub. Date: Feb. 9, 2023

(54) QUANTUM DOT COMPOSITE MATERIAL, AND OPTICAL FILM AND BACKLIGHT MODULE USING SAME

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); Ren-Yu Liao, New Taipei City (TW)

(21) Appl. No.: 17/560,267

(22) Filed: Dec. 23, 2021

(30) Foreign Application Priority Data
Jul. 29, 2021 (TW) 110127813

(51) Int. Cl. C09K 11/02; C08K 3/01; C08F 2/50; C08G 59/17; F21V 8/00; G02B 5/20; G02B 1/04

(52) U.S. Cl. CPC C09K 11/025; C08K 3/01; C08F 2/50; C08G 59/1466; G02B 6/0065; G02B 6/005; G02B 5/206; G02B 1/04; C08K 2201/005; C08K 2201/011; B82Y 20/00

(57) ABSTRACT

A quantum dot composite material, and an optical film and a backlight module using the same are provided. The quantum dot composite material includes a curable polymer and a plurality of quantum dots dispersed in the curable polymer. Based on the total weight of the curable polymer being 100%, the curable polymer includes 15 wt % to 40 wt % of monofunctional group acrylic monomer, 15 wt % to 40 wt % of multifunctional group acrylic monomer, 5 wt % to 35 wt % of mercaptan functional group monomer, 1 wt % to 5 wt % of photoinitiator, 10 wt % to 30 wt % of acrylic oligomer, and 5 wt % to 25 wt % of scattering particles.

### CROSS-REFERENCE TO RELATED PATENT APPLICATION

This application claims the benefit of priority to Taiwan Patent Application No. 110127813, filed on Jul. 29, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a quantum dot composite material, and an optical film and a backlight module using the same, and more particularly to a quantum dot composite material, and an optical film and a backlight module using the same that are applied in the display field.

### BACKGROUND OF THE DISCLOSURE

As the demand for display quality of display devices increases, the development of display devices having high chroma and low thickness is becoming a mainstream trend. Quantum dots have relatively high luminous efficiency, a wide color gamut, and better color purity compared to organic light-emitting diodes (OLEDs). Therefore, in the field of display technology, display devices using quantum dot materials as a backlight source have been developed, so as to provide a better viewing experience to viewers.

However, because the quantum dot materials are not resistant to moisture and oxygen, when contacting the air or moisture, a quantum dot film made from the quantum dot material is easily degraded so that luminous efficiency of the quantum dot film is affected. Usually, in the conventional technology, when the quantum dot film is applied in the display device, two barrier layers (usually resin layers) are adhered to two sides of the quantum dot film respectively, so as to avoid the moisture or oxygen from intruding into the quantum dot film, thus improving the stability of the display device and prolonging service life thereof.

Generally, the quantum dot film has poor moisture and oxygen barrier ability, and is required to be used in cooperation with a barrier film that has high barrier rate. However, the use of the barrier film having a high barrier rate is likely to increase the overall cost and difficulty in production process, and also makes it difficult to decrease the overall product thickness. Due to the foregoing reasons, display products using the quantum dot film have a high market price and are difficult to be popularized. Therefore, how to modify the formulation of the quantum dot film so as to improve its moisture and oxygen barrier ability to overcome the foregoing shortcomings is still one of the important issues to be addressed in this industry.

### SUMMARY OF THE DISCLOSURE

In response to the above-referenced technical inadequacies, the present disclosure provides a quantum dot composite material, and an optical film and a backlight module using the same, in which the quantum dot composite material has high compactness after curing and has a good moisture and oxygen barrier ability.

In one aspect, the present disclosure provides a quantum dot composite material, which includes a curable polymer and a plurality of quantum dots dispersed in the curable polymer. Based on the total weight of the curable polymer being 100%, the curable polymer includes 15 wt % to 40 wt % of monofunctional group acrylic monomer, 15 wt % to 40 wt % of multifunctional group acrylic monomer, 5 wt % to 35 wt % of mercaptan functional group monomer, 1 wt % to 5 wt % of photoinitiator, 10 wt % to 30 wt % of acrylic oligomer, and 5 wt % to 25 wt % of scattering particles.

In another aspect, the present disclosure provides an optical film, which includes a quantum dot layer, a first substrate layer, and a second substrate layer. The quantum dot layer is located between the first substrate layer and the second substrate layer, and is formed by curing a quantum dot composite material. The quantum dot composite material includes a curable polymer and a plurality of quantum dots dispersed in the curable polymer. Based on the total weight of the curable polymer being 100%, the curable polymer includes 15 wt % to 40 wt % of monofunctional group acrylic monomer, 15 wt % to 40 wt % of multifunctional group acrylic monomer, 5 wt % to 35 wt % of mercaptan functional group monomer, 1 wt % to 5 wt % of photoinitiator, 10 wt % to 30 wt % of acrylic oligomer, and 5 wt % to 25 wt % of scattering particles.

In yet another aspect, the present disclosure provides a backlight module, which includes a light guide unit, at least one light-emitting unit, and an optical film. The light guide unit has a light incident side and a light exiting side, and the at least one light-emitting unit is used to produce a light beam projected to the light guide unit. The optical film is disposed at the light incident side of the light guide unit and located between the light guide unit and the at least one light-emitting unit. The optical film includes a quantum dot layer, a first substrate layer, and a second substrate layer. The quantum dot layer is located between the first substrate layer and the second substrate layer, and is formed by curing a quantum dot composite material. The quantum dot composite material includes a curable polymer and a plurality of quantum dots dispersed in the curable polymer. Based on the total weight of the curable polymer being 100%, the curable polymer includes 15 wt % to 40 wt % of monofunctional group acrylic monomer, 15 wt % to 40 wt % of multifunctional group acrylic monomer, 5 wt % to 35 wt % of mercaptan functional group monomer, 1 wt % to 5 wt % of photoinitiator, 10 wt % to 30 wt % of acrylic oligomer, and 5 wt % to 25 wt % of scattering particles.

Therefore, in the quantum dot composite material, and the optical film and the backlight module using the same provided by the present disclosure, by virtue of “the quantum dot composite material including a curable polymer and a plurality of quantum dots dispersed in the curable polymer” and “the curable polymer including 15 wt % to 40 wt % of monofunctional group acrylic monomer, 15 wt % to 40 wt % of multifunctional group acrylic monomer, 5 wt % to 30 wt % of mercaptan functional group monomer, 1 wt % to 5 wt % of photoinitiator, 10 wt % to 30 wt % of acrylic oligomer, and 5 wt % to 25 wt % of scattering particles”, a quantum dot layer formed after curing the quantum dot composite material has a moisture and oxygen barrier ability, thus being applicable to a backlight module of a display device.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic partial cross-sectional diagram of a quantum dot composite material in one embodiment of the present disclosure;

FIG. 2 is a schematic partial cross-sectional diagram of an optical film in one embodiment of the present disclosure; and

FIG. 3 is a schematic diagram of a backlight module of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

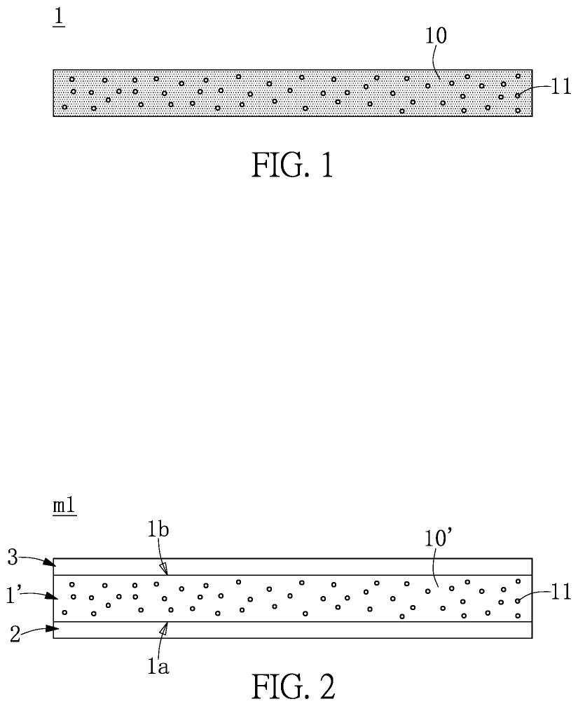

Reference is made to FIG. 1, which is a schematic partial cross-sectional diagram of a quantum dot composite material in one embodiment of the present disclosure. As shown in FIG. 1, the present disclosure provides a quantum dot composite material 1 that at least includes a curable polymer 10 and a plurality of quantum dots 11 dispersed in the curable polymer 10. In one embodiment of the present disclosure, by modifying the composition and proportion of the curable polymer 10, the compactness of the curable polymer 10 after curing can be improved, such that the curable polymer 10 can have a better moisture and oxygen barrier ability and further maintaining certain physical properties (e.g., toughness).

Specifically, based on the total weight of the curable polymer being 100%, the curable polymer 10 includes 15 wt % to 40 wt % of monofunctional group acrylic monomer, 15 wt % to 40 wt % of multifunctional group acrylic monomer, 10 wt % to 30 wt % of acrylic oligomer, 5 wt % to 35 wt % of mercaptan functional group monomer, 1 wt % to 5 wt % of photoinitiator, and 5 wt % to 25 wt % of scattering particles.

The monofunctional group acrylic monomer and the multifunctional group acrylic monomer are both small molecules containing a functional group. In the monofunctional group acrylic monomer, each molecule contains one functional group that can participate in a polymerization reaction; while in the multifunctional group acrylic monomer, each molecule contains a plurality of functional groups that can participate in the polymerization reaction.

Compared to the multifunctional group acrylic monomer, the monofunctional group acrylic monomer has characteristics of a low curing speed, low crosslink density, and low viscosity. Therefore, a higher proportion of the monofunctional group acrylic monomer results in less volume shrinkage and lower crosslink density of the cured quantum dot composite material 1. However, the monofunctional group acrylic monomer assists in enhancing the dispersion of the quantum dots 11.

Conversely, the multifunctional group acrylic monomer enables the quantum dot composite material 1 to have a relatively rapid curing speed and high viscosity. A higher proportion of the multifunctional group acrylic monomer allows for a higher crosslink density of the cured quantum dot composite material 1, but results in higher volume shrinkage and higher brittleness and hardness. In addition, since the multifunctional group acrylic monomer improves the viscosity of the quantum dot composite material 1, a higher proportion of the multifunctional group acrylic monomer may reduce the dispersion of the quantum dots 11 in the curable polymer 10. It should be noted that, if the quantum dots 11 have poor dispersion in the curable polymer 10, the wavelength of excitation light produced after exciting the quantum dots 11 has a relatively wider full width at half maximum, and the quantum dots 11 have poor light conversion efficiency and low brightness, making it difficult to meet demands of actual applications.

Accordingly, in the embodiments provided by the present disclosure, the cured quantum dot composite material 1 has high compactness, and the quantum dots 11 achieve good dispersion in the curable polymer 10, furthermore, excessively high volume shrinkage, hardness and brittleness of the cured quantum dot composite material 1 are avoided.

Based on the foregoing description, the monofunctional group acrylic monomer can improve the dispersion of the quantum dots 11. However, an excessively high proportion of the monofunctional group acrylic monomer may reduce the compactness of the curable polymer 10 after curing, thereby reducing the moisture and oxygen barrier ability and causing an excessively low polymerization speed. Therefore, in the embodiments of the present disclosure, the ratio of the weight percent of the monofunctional group acrylic monomer to that of the multifunctional group acrylic monomer ranges from 0.37 to 2.67. In a preferred embodiment, the ratio of the weight percent of the monofunctional group acrylic monomer to that of the multifunctional group acrylic monomer ranges from 0.5 to 2.5. In a more preferred embodiment, the ratio of the weight percent of the monofunctional group acrylic monomer to that of the multifunctional group acrylic monomer ranges from 0.7 to 1.5, which can enable the quantum dots 11 to have good dispersion in the curable polymer 10 and further can improve the moisture-oxygen barrier property of the curable polymer 10 after curing.

In an embodiment, the monofunctional group acrylic monomer is selected from a group consisting of tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, and ethoxylated (10) bisphenol A dimethacrylate.

In addition, in an embodiment, the multifunctional group acrylic monomer is a trifunctional or tetrafunctional acrylic monomer. Specifically, the multifunctional group acrylic monomer may be selected from a group consisting of trihydroxymethyl propane triacrylate, trihydroxymethyl propane trimethacrylate, ethoxylated (20) trihydroxymethylpropane triacrylate, and pentaerythritol triacrylate.

It should be noted that, an increase in the weight percent concentration of the multifunctional group acrylic monomer can increase the density of the curable polymer 10 after curing, but causes the curable polymer 10 to be brittle and not soft after curing, which is unconducive to subsequent processing. Therefore, in the present disclosure, the quantum dot composite material 1 includes the mercaptan functional group monomer, so that the cured quantum dot composite material 1 not only has relatively high density and good moisture-oxygen barrier property, but also achieves excellent softness and toughness. The softness is determined from whether or not the cured quantum dot composite material 1 can be folded in half without breaking; and the toughness is determined from whether or not the cured quantum dot composite material 1 can be folded in half and can further be wound up under tension.

In a preferred embodiment, the curable polymer 10 includes 5 wt % to 35 wt % of mercaptan functional group monomer. It should be noted that, if the content of the mercaptan functional group monomer is less than 5 wt %, the cured quantum dot composite material 1 may have low softness. Furthermore, the cured quantum dot composite material 1 may be assembled to a display device. If the content of the mercaptan functional group monomer exceeds 35 wt %, the cured quantum dot composite material 1 may be too soft and have too low stiffness (warpage), resulting in inconvenience during assembly. In another preferred embodiment, the curable polymer 10 includes 10 wt % to 30 wt % of mercaptan functional group monomer, which enables the cured quantum dot composite material 1 to have softness and convenience during assembly.

In addition, the addition of the mercaptan functional group monomer can further improve the adhesion of the curable polymer 10. Specifically, in steps of preparing an optical film, the quantum dot composite material 1 may be first formed on another substrate (not shown in the figures), and then a curing step is performed to form a quantum dot layer. If the adhesion between the quantum dot composite material 1 and the substrate is poor, there may be a gap between the quantum dot layer and the substrate after the curing step, thereby reducing the moisture barrier ability of the optical film.

A sum of the weight percent concentration of the mercaptan functional group monomer and that of the multifunctional group acrylic monomer is within a range from 20% to 50%. If the sum of the weight percent concentration of the mercaptan functional group monomer and that of the multifunctional group acrylic monomer is lower than 20%, the quantum dot layer 1′ may have excessively low crosslink density, thereby degrading the moisture-oxygen barrier property of the quantum dot layer 1′. If the sum of the weight percent concentration of the mercaptan functional group monomer and that of the multifunctional group acrylic monomer exceeds 50%, the effects that other components can produce may be inhibited.

In addition, the ratio of the weight percent concentration of the mercaptan functional group monomer to that of the multifunctional group acrylic monomer ranges from 0.17 to 2. In a preferred embodiment, the ratio of the weight percent concentration of the mercaptan functional group monomer to that of the multifunctional group acrylic monomer ranges from 0.4 to 2. By controlling the sum of the weight percent concentration of the mercaptan functional group monomer and that of the multifunctional group acrylic monomer and the ratio between the two, the quantum dot layer 1′ can have good moisture-oxygen barrier property, excellent softness and toughness. Furthermore, the quantum dot layer has stiffness and is prevented from being too soft, thereby facilitating subsequent processing and assembly in the display device.

In this embodiment, the mercaptan functional group monomer is a primary or secondary mercaptan compound; and may be selected from a group consisting of 2,2′-(ethylenedioxy)diethyl mercaptan, 2,2′-thiodiethyl mercaptan, trimethylolpropane tris(3-mercaptopropionate), polyethylene glycol dithiol, pentaerythritol tetrakis(3-mercaptopropionate), ethylene glycol dimercaptoacetate, and ethyl 2-mercaptopropionate.

In addition, in one embodiment, the mercaptan functional group monomer is a non-aromatic compound containing a sulfhydryl functional group (—SH), which can provide functional groups that are more easily bound to the quantum dots 11, so that the quantum dots 11 have good dispersion.

In this embodiment, the acrylic oligomer may be selected from a group consisting of polycarbonate acrylate, polyurethane acrylate, and polybutadiene acrylate. In a preferred embodiment, a content of the acrylic oligomer is approximately 15 wt % to 30 wt %. In addition, a ratio of the concentration of the acrylic oligomer to that of the acrylic monomers (namely, a sum of concentrations of the monofunctional group acrylic monomer and the multifunctional group acrylic monomer) preferably ranges from 0.3 to 0.6. Compared to the multifunctional group acrylic monomer, the acrylic oligomer can also enable the cured quantum dot composite material 1 to have softness. The photoinitiator is used to be excited to generate free radicals, cations or anions after absorbing light energy (for example, ultraviolet light), thereby initiating a polymerization reaction. In one embodiment, the photoinitiator may be selected from a group consisting of 1-hydroxycyclohexyl phenyl ketone, benzoyl isopropanol, tribromomethyl phenyl sulfone, and diphenyl(2,4,6-trimethylbenzoyl)phosphine oxide. The scattering particles have a diameter of 0.5 μm to 20 μm, and are acrylic or silicon dioxide or polystyrene microbeads subjected to surface treatment. However, if the content of the photoinitiator is lower than 1 wt %, curing is difficult, and if the content of the photoinitiator exceeds 5 wt %, volatility of the quantum dot composite material 1 is affected. In a preferred embodiment, the content of the photoinitiator is 3 wt %.

The scattering particles may be microbeads that have a particle size of 0.5 μm to 10 μm and have been subjected to surface treatment. The material of the microbeads may be acrylic, silicon dioxide, germanium dioxide, titanium dioxide, zirconium dioxide, aluminum trioxide, or polystyrene. The scattering particles can scatter the light produced by the quantum dots. Therefore, when an optical film m1 made by using the quantum dot composite material 1 is practically applied in a display device, the light produced by the optical film m1 can be more uniform. It should be noted that, if the content of the scattering particles is lower than 5 wt %, the haze is insufficient, and if the content thereof exceeds 25 wt %, resin content in the material is insufficient, thereby affecting the dispersion of the quantum dots 11 and increasing the processing difficulty.

In addition, in the quantum dot composite material 1, the weight percent concentration of the quantum dots 11 ranges from 0.1 wt % to 4 wt %, and can be adjusted according to actual demands. The quantum dots 11 may include red quantum dots, green quantum dots, blue quantum dots, and any combination thereof For example, the quantum dots 11 include red and green quantum dots, and a ratio of the concentration of the green quantum dots to that of the red quantum dots may range from 1 to 30, which can be adjusted according to practical demands.

In addition, in one embodiment, each of the quantum dots 11 has a core-shell structure, namely, has a core and an outer shell that covers the core. The material of the core/shell of the quantum dots 11 may include cadmium selenide (CdSe)/zinc sulfide (ZnS), indium phosphide (InP)/zinc sulfide (ZnS), lead selenide(PbSe)/lead sulfide(PbS), cadmium selenide(CdSe)/cadmium sulfide(CdS), cadmium telluride (CdTe)/cadmium sulfide (CdS) or cadmium telluride (CdTe)/zinc sulfide (ZnS), but the present disclosure is not limited thereto.

Furthermore, both the core and shell of each of the quantum dots 11 may be Group II-VI, Group II-V, Group Group III-V, Group IV-VI, Group II-IV-VI, or Group II-IV-V composite materials, in which the term “group” indicates the group in the periodic table.

The material of the core may be zinc sulfide (ZnS), zinc selenide (ZnSe), zinc telluride (ZnTe), cadmium sulfide (CdS), cadmium selenide (CdSe), cadmium telluride (CdTe), mercury sulfide (HgS), mercury selenide (HgSe), mercury telluride (HgTe), aluminum nitride (AlN), aluminum phosphide (AlP), aluminum arsenide (AlAs), aluminum antimonide (AlSb), gallium nitride (GaN), gallium phosphide (GaP)), gallium arsenide (GaAs), gallium antimonide (GaSb), gallium selenide (GaSe), indium nitride (InN), indium phosphide (InP), indium arsenide (InAs), indium antimonide (InSb), thallium nitride (TlN), thallium phosphide (TlP), thallium arsenide (TlAs), thallium antimonide (TlSb), lead sulfide (PbS), lead selenide (PbSe), lead telluride (PbTe), or any combination thereof.

The material of the shell may be zinc oxide (ZnO), zinc sulfide (ZnS), zinc selenide (ZnSe), zinc telluride (ZnTe), cadmium oxide (CdO), cadmium sulfide (CdS), cadmium selenide (CdSe), cadmium telluride (CdTe), magnesium oxide (MgO), magnesium sulfide (MgS), magnesium selenide (MgSe), magnesium telluride (MgTe), mercury oxide (HgO), mercury sulfide (HgS), mercury selenide (HgSe), mercury telluride (HgTe), aluminum nitride (AlN), aluminum phosphide (AlP), aluminum arsenide (AlAs), aluminum antimonide (AlSb), gallium nitride (GaN), gallium phosphide (GaP), gallium arsenide (GaAs), gallium antimonide (GaSb), indium nitride (InN), indium phosphide (InP), indium arsenide (InAs), indium antimonide (InSb), thallium nitride (TlN), thallium phosphide (TlP)), thallium arsenide (TlAs), thallium antimonide (TlSb), lead sulfide (PbS), lead selenide (PbSe), lead telluride (PbTe), or any combination thereof.

Reference is made to FIG. 2, which is a schematic partial cross-sectional diagram of an optical film in one embodiment of the present disclosure. Referring to FIG. 2, the optical film m1 in this embodiment includes a quantum dot layer 1′, a first substrate layer 2, and a second substrate layer 3, in which the quantum dot layer 1′ is located between the first substrate layer 2 and the second substrate layer 3.

The quantum dot layer 1′ may be formed by curing the quantum dot composite material 1. Specifically, the quantum dot composite material 1 is formed on the first substrate layer 2, and then covered by the second substrate layer 3 to form a laminated structure. In one embodiment, the quantum dot layer 1′ has a thickness within a range from 30 μm to 130 μm.

Afterwards, a curing step is performed, so that the quantum dot composite layer 1 in the laminated structure is cured to form the quantum dot layer 1′. Further, in the curing step, the laminated structure may be directly irradiated with ultraviolet light, so that the curable polymer 10 of the quantum dot composite material 1 is cured. Accordingly, the quantum dot layer 1′ includes a polymer 10′ that is cured and a plurality of quantum dots 11 scattered in the polymer 10′.

The polymer 10′ is rather compact and thus has a better moisture-oxygen barrier property. Accordingly, the first substrate layer 2 and the second substrate layer 3 do not require to be made from materials that have high moisture-oxygen barrier property. For example, the materials of the first substrate layer 2 and the second substrate layer 3 may be polyester, and the polyester can include the following specific examples: polyethylene terephthalate (PET), polytrimethylene terephthalate (PTT), polybutylene terephthalate (PBT), polyethylene naphthalate (PEN), polybutylene naphthalate (PBN), polycyclohexylenedimethylene terephthalate (PCT), polycarbonate (PC), and polyarylate. Preferably, the polyester is PET. The first substrate layer 2 and the second substrate layer 3 each has a thickness within a range from 20 μm to 125 μm.

That is, the quantum dot layer 1′ formed by curing the quantum dot composite material 1 in the embodiments of the present disclosure has an excellent moisture-oxygen barrier property. Therefore, the optical film m1 is not required to have a high-cost moisture-oxygen barrier layer disposed thereon, thereby reducing an overall cost and process difficulty of the optical film m1. In addition, an overall thickness of the optical film m1 can also be reduced. In one embodiment, the overall thickness of the optical film m1 is within a range from 90 nm to 380 nm.

Referring to table 1, table 1 shows various index parameters of the optical films formed by using the material in a comparative embodiment and the quantum dot composite material 1 in the embodiments of the present disclosure. In the comparative embodiment and Embodiments 1 to 6, the quantum dot composite materials 1 used to form the quantum dot layer 1′ all contain 1.6 wt % of quantum dots 11. However, in the curable polymer 10, the mercaptan functional group monomer, the acrylic monomers, and the acrylic oligomer have different proportions. In addition, the first substrate layer and the second substrate layer used in the comparative embodiment and Embodiments 1 to 6 are made from the same materials.

A measurement manner of the various index parameters in table 1 is as follows.

Warpage: a sample of 10 cm×10 cm is used in the test, one end thereof is adhered and the warpage height of another end is measured.

Adhesion: a tensile machine is used for the test. During the test, the quantum dot layer is sandwiched between the first and second substrate layers before a pull test. If the three layers cannot be pulled apart, and the first and second substrate layers are not broken, the adhesion is recorded as “good”. If the three layers can be pulled apart, and the first and second substrate layers both have an adhesive layer, the adhesion is recorded as “normal”. If the three layers can be pulled apart, and only one substrate layer has the adhesive layer, the adhesion is recorded as “poor”.

Brightness: a brightness meter (a spectrophotometer, model number SR-3AR) is used for the test. Excitation is performed under the conditions of a 12 W blue light source, color coordinates of x=0.155 and y=0.026, a dominant wavelength of 450 nm, and a full width at half maximum of 20 nm, and measurement is performed under irradiation by the backlight module.

Cycle test: a cycle test chamber is used for testing at 65° C. and a relative humidity of 95% to measure the differences in color coordinates and the change in brightness before and after the cycle test.

Shrinkage: the percentage of a volume difference before and after curing to the volume before curing is measured.

TABLE 1

| | | | | | | | Comparative |
|---|---|---|---|---|---|---|---|
| Proportion | Embodiment 1 | Embodiment 2 | Embodiment 3 | Embodiment 4 | Embodiment 5 | Embodiment 6 | embodiment |
| Monofunc- | 30 | 30 | 22 | 12 | 12 | 12 | 20 |
| tional group | | | | | | | |
| acrylic | | | | | | | |
| monomer | | | | | | | |
| (wt %) | | | | | | | |
| Multifunc- | 30 | 30 | 25 | 25 | 15 | 15 | 47 |
| tional group | | | | | | | |
| acrylic | | | | | | | |
| monomer | | | | | | | |
| (wt %) | | | | | | | |
| Mercaptan | 2 | 5 | 10 | 20 | 30 | 35 | 0 |
| functional | | | | | | | |
| group | | | | | | | |
| monomer | | | | | | | |
| (wt %) | | | | | | | |
| Acrylic | 15 | 12 | 20 | 20 | 20 | 15 | 20 |
| oligomer | | | | | | | |
| (wt %) | | | | | | | |
| Photoinitiator | 3 | 3 | 3 | 3 | 3 | 3 | 3 |
| (wt %) | | | | | | | |
| Scattering | 20 | 20 | 20 | 20 | 20 | 20 | 10 |
| particles | | | | | | | |
| (wt %) | | | | | | | |

Characteristics

| | | | | | | | |
|---|---|---|---|---|---|---|---|
| Warpage | 3 mm | 2.5 mm | 2.5 mm | 2 mm | 2 mm | 1.5 mm | 4 mm |
| Adhesion | Good | Good | Good | Good | Good | Good | Poor |
| Shrinkage | 0.6% | 0.4% | 0.3% | 0.2% | 0.2% | 0.2% | 0.7% |
| (%) | | | | | | | |
| Brightness | 4012 | 4500 | 4511 | 4628 | 4597 | 4483 | 4213 |
| (cd/m²) | | | | | | | |
| Cycle-test | 4.4% | 0.64% | 0.61% | 0.45% | 0.54% | 0.56% | 11.9% |
| brightness | | | | | | | |
| decay rate | | | | | | | |
| Cycle-test | Δx | Δx | Δx | Δx | Δx | Δx | Δx |
| color | 0.0058 | 0.0027 | 0.0035 | 0.0011 | 0.0029 | 0.0044 | 0.0067 |
| coordinate | (0.3071 | (0.3071 | (0.3055 | (0.3067 | (0.3042 | (0.3122 | (0.301 |
| changes | → | → | → | → | → | → | → |
| | 0.3044) | 0.3044) | 0.3020) | 0.3056) | 0.3013) | 0.3078) | 0.2943) |
| | Δy | Δy | Δy | Δy | Δy | Δy | Δy |
| | 0.0122 | 0.0028 | 0.0022 | 0.0025 | 0.0044 | 0.0031 | 0.0443 |
| | (0.3025 | (0.3025 | (0.3047 | (0.3039 | (0.3011 | (0.3025 | (0.2994 |
| | → | → | → | → | → | → | → |
| | 0.2913) | 0.2997) | 0.3025) | 0.3014) | 0.2967) | 0.2994) | 0.2551) |

It can be learned from table 1 that, in the comparative embodiment, when no mercaptan functional group monomer is added and only the proportion of the acrylic monomers (including the monofunctional group acrylic monomer and the multifunctional group acrylic monomer) is increased, the curing speed is rapid, but the quantum dot layer has high shrinkage and low adhesion, and is easy to curl, uneven, and more likely to crack after curing.

The quantum dot composite materials used in the optical films in Embodiments 1 to 6 all contain the mercaptan functional group monomer. Compared to the comparative embodiment, after curing, the quantum dot layer 1′ in Embodiments 1 to 6 has good adhesion to both the first substrate layer 2 and the second substrate layer 3. Further, referring to table 1, compared to the cycle-test brightness decay rate (11.9%) in the comparative embodiment, the cycle-test brightness decay rates (0.45% to 4.4%) and the cycle-test color coordinate changes in Embodiments 1 to 6 are all relatively low, which can prove that the optical films in Embodiments 1 to 6 are obviously superior to the optical film in the comparative embodiment in terms of the moisture-oxygen barrier property.

In addition, in the embodiments of the present disclosure, in the curable polymer 10 of the quantum dot composite material 1, the ratio of the weight percent of the monofunctional group acrylic monomer to that of the multifunctional group acrylic monomer ranges from 0.5 to 2.5, so that the quantum dots 11 achieve good dispersion in the curable polymer 10, and the moisture-oxygen barrier property of the curable polymer 10 can be further improved after curing.

The optical properties of the optical film m1 in the embodiments of the present disclosure are tested by using a brightness meter (a spectrophotometer, model number SR-3AR). The test results show that, a full width at half maximum of the wavelength of the red light produced by the optical film m1 in the embodiments of the present disclosure does not exceed 35 nm, and is preferably within a range from 25 nm to 30 nm. Furthermore, a full width at half maximum of the wavelength of the green light produced by the optical film m1 in the embodiments of the present disclosure does not exceed 30 nm, and is preferably within a range from 20 nm to 25 nm. In addition, the test results further show that when the optical film m1 in the embodiments of the present disclosure emits light, the brightness is greater than 3100 cd/m², and can preferably reach 4000 cd/m² to 5000 cd/m². The foregoing test results prove that the quantum dot layer 1′ (the quantum dot composite material 1 after being cured) provided in Embodiments 1 to 6 of the present disclosure not only has a good moisture-oxygen barrier property, but also enables the quantum dots 11 to achieve good dispersion.

In addition, in the quantum dot composite material used in the optical film m1 in Embodiments 1 to 6, the ratio of the mercaptan functional group monomer to the multifunctional group acrylic monomer ranges from 0.07 to 2.3. Compared to the comparative embodiment, the optical film m1 in Embodiments 1 to 6 has desired softness such that its warpage (stiffness) is relatively low. As the ratio of the mercaptan functional group monomer to the multifunctional group acrylic monomer gradually increases, the softness of the optical film m1 is increasingly higher, and the warpage is increasingly lower.

Generally, an optical film with higher warpage also has higher stiffness, thereby facilitating subsequent processing or assembly of the optical film. In the quantum dot composite material 1 used in the optical film m1 in Embodiments 2 to 5, the ratio of the mercaptan functional group monomer to the multifunctional group acrylic monomer ranges from 0.17 to 2, and the warpage of the optical film m1 is within a range from 2 mm to 2.5 mm, so that the optical film has desired softness and an appropriate range of stiffness (warpage), thus facilitating subsequent processing or assembly.

In comprehensive consideration of the characteristics such as adhesion, cycle-test brightness decay rate, cycle-test color coordinate changes, and warpage, in the quantum dot composite material 1 used in the optical film m1 in Embodiments 3 to 5, a sum of the weight percent concentration of the mercaptan functional group monomer and that of the multifunctional group acrylic monomer ranges from 35% to 45%, and the ratio of the mercaptan functional group monomer to the multifunctional group acrylic monomer ranges from 0.4 to 2, so that the quantum dot composite material 1 combines softness, moisture-oxygen barrier property, and processing and assembly convenience.

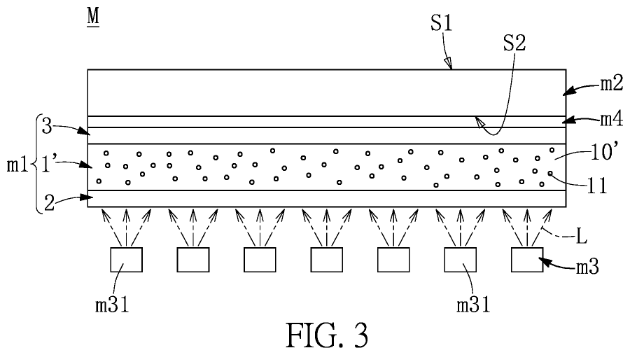

Accordingly, the optical film m1 in the embodiments of the present disclosure is applicable to a backlight module of a display device. Referring to FIG. 3, FIG. 3 is a schematic diagram of a backlight module in one embodiment of the present disclosure, in which a backlight module M includes an optical film m1, a light guide unit m2, and at least one light-emitting unit m3.

The light guide unit m2 may include at least one of a light guide plate, a reflector, a diffuser, a prism, and a polarizer, which are not limited in the present disclosure. The light guide unit m2 has a light incident side S1 and a light exiting side S2.

The at least one light-emitting unit m3 is used to produce light beams L projected to the light guide unit m2 As shown in FIG. 3, the light-emitting unit m3 in this embodiment includes a plurality of light-emitting elements m31, in which the plurality of light-emitting elements m31 may be arranged in an array and is correspondingly disposed at the light incident side S1 of the light guide unit m2 In addition, the optical film m1 is disposed at the light incident side S1 of the light guide unit m2 and located between the light guide unit m2 and the light-emitting unit m3.

In this embodiment, the optical film m1 may be the optical film m1 shown in FIG. 2, which includes a quantum dot layer 1′, a first substrate layer 2, and a second substrate layer 3, in which the quantum dot layer 1′ is located between the first substrate layer 2 and the second substrate layer 3. In other words, the quantum dot layer 1′ has a first surface la and a second surface 1b that are opposite to each other, in which the first substrate layer 2 is adhered to the first surface la and the second substrate layer 3 is adhered to the second surface 1b. In this embodiment, the optical film m1 is connected to the light guide unit m2 via the second substrate layer 3. Specifically, the optical film m1 may be fixed at the light incident side S1 of the light guide unit m2 via an optical adhesive layer m4. The materials of the quantum dot layer 1′, the first substrate layer 2, and the second substrate layer 3 have been described above, so the details are not described herein again.

It should be noted that, after the light beams L produced by the light-emitting unit m3 enters the quantum dot layer 1′, a portion of the light beams L can excite the quantum dots 11 in the quantum dot layer 1′ to produce excitation beams that have a different wavelength from the light beams L. That is, after the light beams L produced by the light-emitting unit m3 pass through the quantum dot layer 1′, mixed beams (including the light beams and the excitation beams) are produced, and then enter the light guide unit m2 through the light incident side S1 of the light guide unit m2.

In addition, the quantum dot layer 1′ in the embodiments of the present disclosure has good moisture-oxygen barrier property, so that it does not require an additional high-cost moisture-oxygen barrier layer to protect the quantum dot layer 1′, thereby reducing the cost of the optical film m1 and further decreasing the overall thickness of the optical film m1. When the optical film m1 in the embodiments of the present disclosure is applied in the backlight module M of the display device, the thickness of the backlight module M can be further decreased.

### Beneficial Effects of the Embodiments

In the quantum dot composite material, and the optical film and the backlight module using the same provided by the present disclosure, by virtue of “the quantum dot composite material including a curable polymer 10 and a plurality of quantum dots 11 dispersed in the curable polymer 10” and “the curable polymer 10 including 15 wt % to 40 wt % of monofunctional group acrylic monomer, 15 wt % to 40 wt % of multifunctional group acrylic monomer, 5 wt % to 30 wt % of mercaptan functional group monomer, 1 wt % to 5 wt % of photoinitiator, 10 wt % to 30 wt % of acrylic oligomer, and 5 wt % to 25 wt % of scattering particles”, a quantum dot layer 1′ formed after curing the quantum dot composite material 1 has a moisture and oxygen barrier ability, thus being applicable to an optical film m1 and a backlight module M of a display device.

Further, by controlling the sum of the mercaptan functional group monomer and the multifunctional group acrylic monomer and the ratio between the two, the quantum dot layer 1′ formed after curing the quantum dot composite material 1 provided by the embodiments of the present disclosure not only has high compactness and a good moisture-oxygen barrier ability, but also has desired softness and toughness, and is not easily cracked. In addition, the optical film m1 produced by using the quantum dot composite material 1 provided by the embodiments of the present disclosure has appropriate stiffness. Therefore, when applied in a display device, the optical film m1 that has appropriate stiffness can improve the assembly convenience.

Moreover, by controlling the ratio of the monofunctional group acrylic monomer to the multifunctional group acrylic monomer, the quantum dots 11 can achieve good dispersion in the curable polymer 10. Accordingly, a full width at half maximum of the wavelength and the brightness of the excitation light (red light and green light) produced by exciting the quantum dot layer 1′ in the embodiments of the present disclosure can both meet the application standards.

Compared to the existing quantum dot film, the quantum dot layer 1′ in the embodiments of the present disclosure has a good moisture-oxygen barrier property. Therefore, the first substrate layer 2 and the second substrate layer 3 respectively located at the two sides of the quantum dot layer 1′ are not required to be made from a high-cost moisture-oxygen barrier material, and a low-cost material such as PET can be selected, thereby reducing the overall manufacturing cost and process difficulty of the optical film m1.

In addition, by controlling the contents of the mercaptan functional group monomer and the acrylic monomers (including the monofunctional group acrylic monomer and the multifunctional group acrylic monomer), the quantum dot layer 1′ in the embodiments of the present disclosure has good adhesion to both the first substrate layer 2 and the second substrate layer 3, so that moisture and oxygen do not easily penetrate into the quantum dot layer 1′ from a joint face between the first substrate layer 2 (or the second substrate layer 3) and the quantum dot layer 1′, thereby further improving the moisture-oxygen barrier property of the optical film m1.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A quantum dot composite material, comprising a curable polymer and a plurality of quantum dots dispersed in the curable polymer, wherein, based on the total weight of the curable polymer being 100 wt %, the curable polymer includes:
15 wt % to 40 wt % of monofunctional group acrylic monomer;
15 wt % to 40 wt % of multifunctional group acrylic monomer;
5 wt % to 35 wt % of mercaptan functional group monomer;
1 wt % to 5 wt % of photoinitiator;
10 wt % to 30 wt % of acrylic oligomer; and
5 wt % to 25 wt % of scattering particles.

2. The quantum dot composite material of claim 1, wherein the monofunctional group acrylic monomer is selected from a group consisting of tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, and ethoxylated (10) bisphenol A dimethacrylate; and the multifunctional group acrylic monomer is selected from a group consisting of trihydroxymethyl propane triacrylate, trihydroxymethyl propane trimethacrylate, ethoxylated (20) trihydroxymethylpropane triacrylate, and pentaerythritol triacrylate.

3. The quantum dot composite material of claim 1, wherein the acrylic oligomer is selected from a group consisting of polycarbonate acrylate, polyurethane acrylate, and polybutadiene acrylate.

4. The quantum dot composite material of claim 1, wherein the mercaptan functional group monomer is a primary or secondary mercaptan compound; and is selected from a group consisting of 2,2′-(ethylenedioxy)diethyl mercaptan, 2,2′-thiodiethyl mercaptan, trimethylolpropane tris(3-mercaptopropionate), polyethylene glycol dithiol, pentaerythritol tetrakis(3-mercaptopropionate), ethylene glycol dimercaptoacetate, and ethyl 2-mercaptopropionate.

5. The quantum dot composite material of claim 1, wherein the multifunctional group acrylic monomer is selected from a group consisting of trihydroxymethyl propane triacrylate, trihydroxymethyl propane trimethacrylate, ethoxylated (20) trihydroxymethylpropane triacrylate, and pentaerythritol triacrylate.

6. The quantum dot composite material of claim 1, wherein the scattering particles have a diameter of 0.5 μm to 10 μm, and are acrylic or silicon dioxide or polystyrene microbeads subjected to surface treatment.

7. The quantum dot composite material of claim 1, wherein the weight percent concentration of the quantum dot material ranges from 0.1 wt % to 4 wt %.

8. The quantum dot composite material of claim 1, wherein the plurality of quantum dots include red quantum dots and green quantum dots, and a ratio between concentrations of the green quantum dots to concentrations of the red quantum dots ranges from 1 to 30.

9. The quantum dot composite material of claim 1, wherein a ratio of the weight percent concentration of the monofunctional group acrylic monomer to that of the multifunctional group acrylic monomer ranges from 0.5 to 2.5.

10. The quantum dot composite material of claim 1, wherein a sum of the weight percent concentration of the mercaptan functional group monomer and that of the multifunctional group acrylic monomer is within a range from 20% to 50%, and the ratio of the weight percent concentration of the mercaptan functional group monomer to that of the multifunctional group acrylic monomer ranges from 0.4 to 2.

11. An optical film, comprising: a quantum dot layer, a first substrate layer, and a second substrate layer, wherein the quantum dot layer is located between the first substrate layer and the second substrate layer, and the quantum dot layer is formed by curing a quantum dot composite material; and wherein the quantum dot composite material includes a curable polymer and a plurality of quantum dots dispersed in the curable polymer, and based on the total weight of the curable polymer being 100%, the curable polymer includes:
15 wt % to 40 wt % of monofunctional group acrylic monomer;
15 wt % to 40 wt % of multifunctional group acrylic monomer;
5 wt % to 35 wt % of mercaptan functional group monomer;
1 wt % to 5 wt % of photoinitiator;
10 wt % to 30 wt % of acrylic oligomer; and
5 wt % to 25 wt % of scattering particles.

12. The optical film of claim 11, wherein the first substrate layer and the second substrate layer are made from polyethylene terephthalate, and both have a thickness within a range from 20 μm to 120 μm.

13. The optical film of claim 11, wherein the thickness of the quantum dot layer is within a range from 30 μm to 130 μm.

14. A backlight module, comprising:
a light guide unit having a light incident side and a light exiting side;
at least one light-emitting unit used to produce a light beam projected to the light incident side; and
an optical film disposed at the light incident side of the light guide unit and located between the light guide unit and the at least one light-emitting unit, wherein the optical film includes:
a quantum dot layer having a first surface and a second surface;
a first substrate layer adhered to the first surface of the quantum dot layer; and
a second substrate layer adhered to the second surface of the quantum dot layer and connected to the light guide unit;
wherein the quantum dot layer is formed by curing a quantum dot composite material; wherein the quantum dot composite material includes a curable polymer and a plurality of quantum dots dispersed in the curable polymer, and based on the total weight of the curable polymer being 100%, the curable polymer includes:
15 wt % to 40 wt % of monofunctional group acrylic monomer;
15 wt % to 40 wt % of multifunctional group acrylic monomer;
5 wt % to 35 wt % of mercaptan functional group monomer;
1 wt % to 5 wt % of photoinitiator;
10 wt % to 30 wt % of acrylic oligomer; and
5 wt % to 25 wt % of scattering particles.
